(19) United States
(12) Patent Application Publication
(10) Pub. No.: US 2018/0293756 A1
(43) Pub. Date: Oct. 11, 2018

(54) ENHANCED LOCALIZATION METHOD AND APPARATUS

(71) Applicant: Intel Corporation, Santa Clara, CA (US)

(72) Inventors: Zhongxuan LIU, Beijing (CN); Liwei MA, Beijing (CN)

(21) Appl. No.: 15/567,596

(22) PCT Filed: Nov. 18, 2016
(86) PCT No.: PCT/CN2016/106328

§ 371 Date: Oct. 18, 2017

(51) Int. Cl. G06T 7/80; G06K 9/62; G06T 7/73; G06T 7/37; G06N 3/04; G01P 15/08

(52) U.S. Cl. CPC G06T 7/80; G06K 9/6289; G06T 7/74; G06T 2207/20084; G06N 3/04; G01P 15/0802; G06T 7/37

(57) ABSTRACT

Methods, apparatus, and system to obtain a pose from image regression in a trained convolutional neural network (“CNN”), to refine the CNN pose based on inertial measurements from an inertial measurement unit, and to infer a pose of a camera which took the image based on the refined CNN pose.

### FIELD

The present disclosure relates to the field of computing, in particular to, enhanced localization of a computing device.

### BACKGROUND

Many objects and computer devices need to be localized for a wide range of reasons. For example, service robots, unmanned aerial vehicles, sub-sea robots, semi- and fully autonomous self-driving vehicles, augmented and virtual reality systems, mobile telephones, and the like must or at least should be localized to perform many desired operations.

As used herein, “localization” is defined as determining the location and, optionally, orientation (collectively referred to herein as “pose”) of an object relative to a map. As used herein, “location” and “position” are synonyms. As used herein, “orientation” may be according to one, two, three or more axes of rotation (three axes of rotation may also be referred to as yaw, pitch, and roll). As used herein, a map may comprise two or three dimensions in a coordinate system (such as a grid coordinate system, a polar coordinate system, latitude and longitude, and the like).

Many location services exist. For example, mobile phones commonly include Global Positioning Systems (“GPS”) to multi-laterate (bilaterate, trilatate, etc.) the location of mobile phones based on the position of GPS satellites and time-of-flight of electromagnetic radiation transmitted by the GPS satellites. Terrestrial location services may also multi-laterate the location of objects and computer devices, whether from the perspective of the object or device or from the perspective of an observer of the object or device.

Computer devices may also include sensors and associated processing equipment to contribute to pose determination and/or to determine physical objects in a surrounding environment. Examples of such sensors and processing equipment include inertial measurement units, compasses, light detection and ranging (“LIDAR”) systems, radio detection and ranging (“RADAR”) systems, sound navigation and ranging (“SONAR”) systems, and visual odometry systems (which estimate distance traveled from sequences of images).

Certain sensor systems, such as inertial measurement systems, can be used without external input to provide “dead reckoning”, which is to say, to estimate the pose of a device based on its movement over time.

### BRIEF DESCRIPTION OF THE DRAWINGS

FIG. 1 is a network and device diagram illustrating an example of at least one mobile computer device in an area, proximate to an area feature, in a network environment and potentially in communication with a mobile device datastore and a convolutional neural network server, incorporated with teachings of the present disclosure, according to some embodiments.

FIG. 2 is a functional block diagram illustrating an example of a mobile computer device incorporated with teachings of the present disclosure, according to some embodiments.

FIG. 3 is a functional block diagram illustrating an example of a mobile device datastore for practicing the present disclosure, consistent with embodiments of the present disclosure.

FIG. 4 is a flow diagram illustrating an example of a method performed by a localization module, according to some embodiments.

FIG. 5 is a flow diagram illustrating an example of a method performed by a location use module, according to some embodiments.

Although the following Detailed Description will proceed with reference being made to illustrative embodiments, many alternatives, modifications, and variations thereof will be apparent to those skilled in the art.

### DETAILED DESCRIPTION

In addition to terms defined in the Background section, following are defined terms in this document.

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures.

As used herein, a process corresponds to an instance of a program, e.g., an application program, executing on a processor and a thread corresponds to a portion of the process. A processor may include one or more execution core(s). The processor may be configured as one or more socket(s) that may each include one or more execution core(s).

A convolutional neural network (“CNN”), also known as a shift invariant or space invariant artificial neural network, is a type of feed-forward artificial neural network consisting of artificial neurons. Artificial neurons are functions which receive one or more inputs and sum them to produce an output. The sums of each neuron may be weighted and may be passed through a non-linear activation or transfer function, sometimes referred to as a threshold logic gate (which may have a sigmoid shape or a form of another non-linear function, such as a piecewise linear function or step function). The artificial neurons in a CNN may be designed with receptive fields which at least partially overlap, tiling a visual field. Tiling allows CNNs to tolerate translation of input images. CNNs may include local or global pooling layers which combine the outputs of neuron clusters. A CNN may be trained with images of an area; when presented with images of the area, the trained CNN will provide or return a pose of a camera used to take the presented images (the provided or returned pose hereinafter being referred to as a “CNN pose”). Once a CNN is trained to recognize images of an area and respond with CNN poses, the trained CNN may be provided to a computer device, such that the computer device can process images with the CNN locally (relative to the computer device), and/or a computer device may provide images to an external device which hosts the trained CNN and obtain a CNN pose as a service.

CNN regression to generate CNN poses offers fine global localization and a high call back rate (a fine re-localization result can be obtained for most image frames), though compared with LIDAR, visual odometry, and dead reckoning via inertial measurement, CNN regression has comparatively lower precision. Compared with LIDAR and some other systems, CNN regression has lower cost and a higher re-localization call back rate. Dead reckoning via inertial measurement can be very precise for short distances (generally tens of meters), with a high frame rate, and with low computational cost. In contrast to dead reckoning via inertial measurement, CNN regression offers lower cumulative drift error. Compared with visual odometry, CNN regression has a higher call back rate and a nearly constant time cost for each frame.

In overview, this disclosure relates to methods and systems in a computer device apparatus to obtain a pose from image regression in a trained CNN (a “CNN pose”), to refine the CNN pose based on inertial measurements from an inertial measurement unit (“IMU”), and to infer a pose of the computer device (or a camera) based on the refined CNN pose. The refined result further provides greater accuracy compared to an unrefined CNN pose, without the drift error endemic in dead reckoning via inertial measurement, and with an almost constant computational time cost.

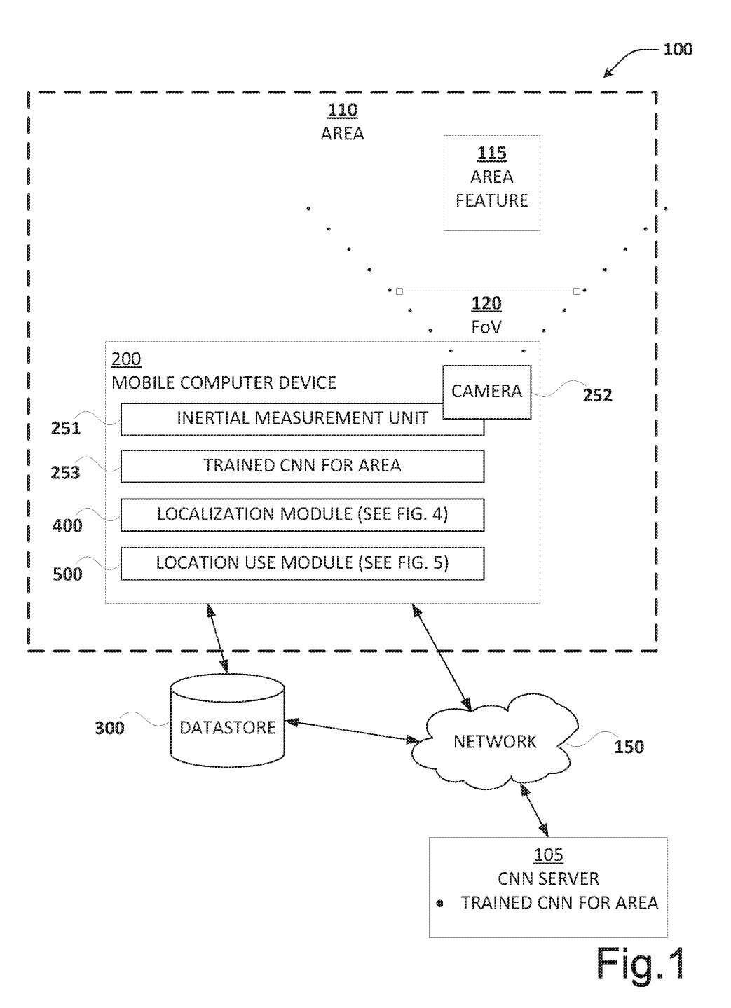

FIG. 1 is a network and device diagram illustrating an example of at least one mobile computer device 200 located in an area 110, within at least visual range of area feature 115. Mobile computer device 200, except for the teachings of the present disclosure, may include, but is not limited to, an augmented and/or virtual reality display or supporting computers therefore, a robot, an autonomous or semi-autonomous vehicle, a game console, a set-top box, a server, a workstation computer, a desktop computer, a laptop computer, a tablet computer (e.g., iPad®, GalaxyTab® and the like), an ultraportable computer, an ultramobile computer, a netbook computer and/or a subnotebook computer; a mobile telephone including, but not limited to a smart phone, (e.g., iPhone®, Android®-based phone, Blackberry®, Symbian®-based phone, Palm®-based phone, etc.), and/or a feature phone. Mobile computer device 200 may not be mobile (the expression, “mobile computer device” should be understood as a label, not as a requirement), but may nonetheless have a need for localization services.

Mobile computer device 200 may use network 150 to communicate with, for example, datastore 300 and/or CNN server 105. Mobile computer device 200 may obtain CNN poses by providing images to, for example, a CNN trained for an area, such as area 110. The CNN trained for the area may be executed by mobile computer device 200 (referred to herein as, “trained CNN for area 253”) and/or the mobile computer device 200 may provide images to a remote CNN server 105, wherein the remote CNN server 105 may host a CNN trained for the area. Different CNNs trained for different areas may exist, each associated with a different area. For example trained CNN for area 253 may be trained for area 110, while another trained CNN may be trained for another area. Different areas may be, for example, geographic areas, buildings, and the like. Identifiers for different areas, such as area 110, may be stored in datastore 300 as, for example, one or more area 335 records.

Mobile computer device 200 may comprise camera 252. Camera 252 may be any one of a number of known cameras. For example, camera 252 may be a conventional camera which records RGB pixels or camera 252 may be a camera which records depth information in addition to RGB data. Camera 252 may be, for example, a REALSENSE(™) camera or a camera compatible with the REALSENSE(™) platform.

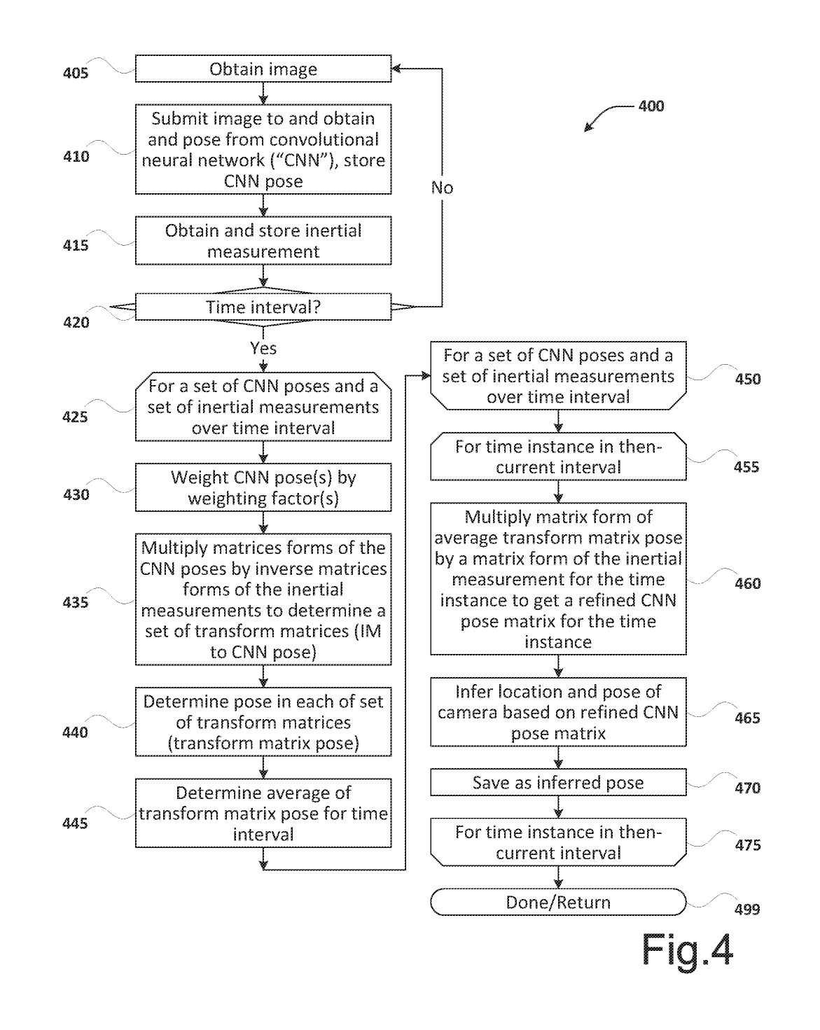

Camera 252 may have a field of view (“FoV”) 120; as illustrated in FIG. 1, FoV 120 includes area feature 115. Images recorded by camera 252 may include images of area feature 115. Camera 252 may comprise or be associated with software and/or firmware instructions to operate camera 252 to take and record images; an example of such instructions is discussed herein in relation to localization module 400 (see FIG. 4). Pixels for or of images may be recorded in, for example, one or more image 305 records in datastore 300. Images recorded by camera 252 may be submitted to trained CNN for area 253 to obtain CNN poses.

As illustrated in FIG. 1, mobile computer device 200 may also comprise inertial measurement unit 251. Inertial measurement unit 251 may be physically and rigidly coupled to camera 252, such that movement of camera 252 is measured by inertial measurement unit 251. Inertial measurement unit 251 may comprise sensors, such as accelerometers, gyroscopes, and/or magnetometers, to measure specific force (typically in units of acceleration), angular rate, and (optionally) magnetic field. Inertial measurement unit 251 may be associated with software and/or firmware instructions to operate inertial measurement unit 251 to record inertial measurements; an example of such instructions is discussed herein in relation to localization module 400 (see FIG. 4). Inertial measurements may be recorded in, for example, one or more inertial measurement 315 records in datastore 300.

As discussed at greater length herein, mobile computer device 200 may execute localization module 400 and location use module 500. Localization module 400 may submit images taken by camera 252, such as image 305 records, to trained CNN for area 253 (or to an equivalent trained CNN in, for example, CNN server 105). Trained CNN for area 253 may respond to submitted images with corresponding CNN poses. CNN poses returned by trained CNN for area 253 may be stored in datastore 300 as, for example, on or more CNN pose 310 records. Localization module 400 may also obtain and store inertial measurements from inertial measurement unit 251. Localization module 400 may refine the CNN poses based on the inertial measurements, and infer a pose of mobile computer device 200 (or at least of camera 252) based on the refined CNN pose. The inferred pose may be saved in datastore 300 as, for example, one or more inferred pose 330 records. The inferred pose provide greater accuracy compared to an unrefined CNN pose, without the drift error endemic in dead reckoning via inertial measurement, and with an almost constant computational time cost.

Mobile computer device 200 may also execute location use module 500 to use inferred poses generated by localization module 400.

Also illustrated in FIG. 1 is datastore 300. Datastore 300 is described further, herein, though, generally, it should be understood as a datastore used by mobile computer device 200.

Also illustrated in FIG. 1 is network 150. Network 150 may comprise computers, switches, routers, gateways, network connections among the computers, and software routines to enable communication between the computers over the network connections. Examples of Network 150 comprise wired networks, such as an Ethernet networks, and/or a wireless networks, such as a WiFi, GSM, TDMA, CDMA, EDGE, HSPA, LTE or other network provided by a wireless service provider; local and/or wide area; private and/or public, such as the Internet. More than one network may be involved in a communication session between the illustrated devices. Connection to Network 150 may require that the computers execute software routines which enable, for example, the seven layers of the OSI model of computer networking or equivalent in a wireless phone network.

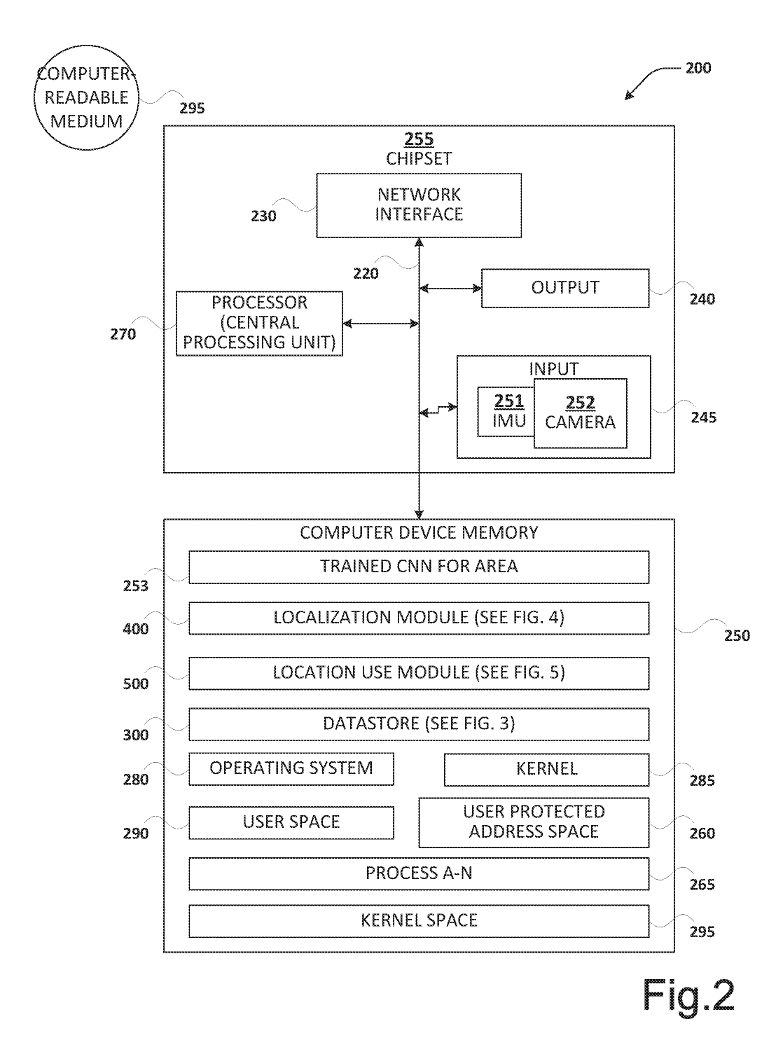

FIG. 2 is a functional block diagram illustrating an example of mobile computer device 200 incorporated with the teachings of the present disclosure, according to some embodiments. Mobile computer device 200 may include chipset 255, comprising processor 270, input/output (I/O) port(s) and peripheral device interfaces, such as output interface 240 and input interface 245, and network interface 230; and computer device memory 250, all interconnected via bus 220. Processor 270 may include one or more processor cores (central processing units (CPU)). Network Interface 230 may be utilized to couple processor 270 to a network interface card (NIC) to form connections with network 150, with datastore 300, or to form device-to-device connections with other computers.

Chipset 255 may include communication components and/or paths, e.g., buses 220, that couple processor 270 to peripheral devices, such as, for example, output interface 240 and input interface 245, which may be connected via I/O ports. For example, chipset 255 may include a peripheral controller hub (PCH) (not shown). In another example, chipset 255 may include a sensors hub. Input interface 245 and output interface 240 may couple processor 270 to input and/or output devices that include, for example, user and machine interface device(s) including a display, a touch-screen display, printer, keypad, keyboard, etc., sensor(s) including inertial measurement unit 251, camera 252, global positioning system (GPS), etc., storage device(s) including hard disk drives, solid-state drives, removable storage media, etc. I/O ports for input interface 245 and output interface 240 may be configured to transmit and/or receive commands and/or data according to one or more communications protocols. For example, one or more of the I/O ports may comply and/or be compatible with a universal serial bus (USB) protocol, peripheral component interconnect (PCI) protocol (e.g., PCI express (PCIe)), or the like.

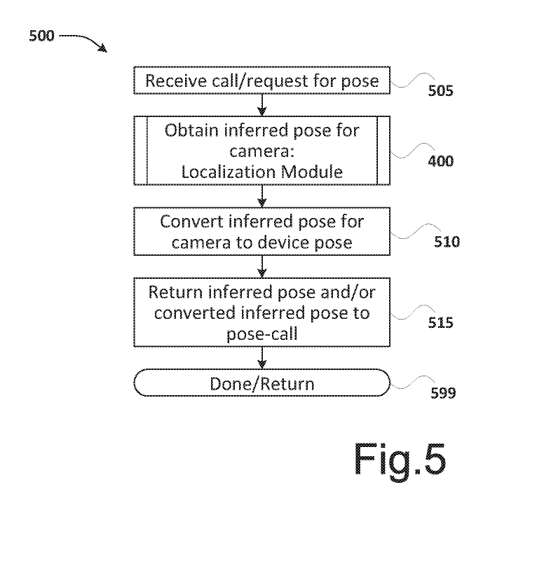

Computer device memory 250 may generally comprise a random access memory (“RAM”), a read only memory (“ROM”), and a permanent mass storage device, such as a disk drive or SDRAM (synchronous dynamic random-access memory). Computer device memory 250 may store program code for software modules or routines, such as, for example, trained CN for area 253, localization module 400 (illustrated and discussed further in relation to FIG. 4), and location use module 500 (illustrated and discussed further in relation to FIG. 5).

Computer device memory 250 may also store operating system 280. These software components may be loaded from a non-transient computer readable storage medium 295 into computer device memory 250 using a drive mechanism associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

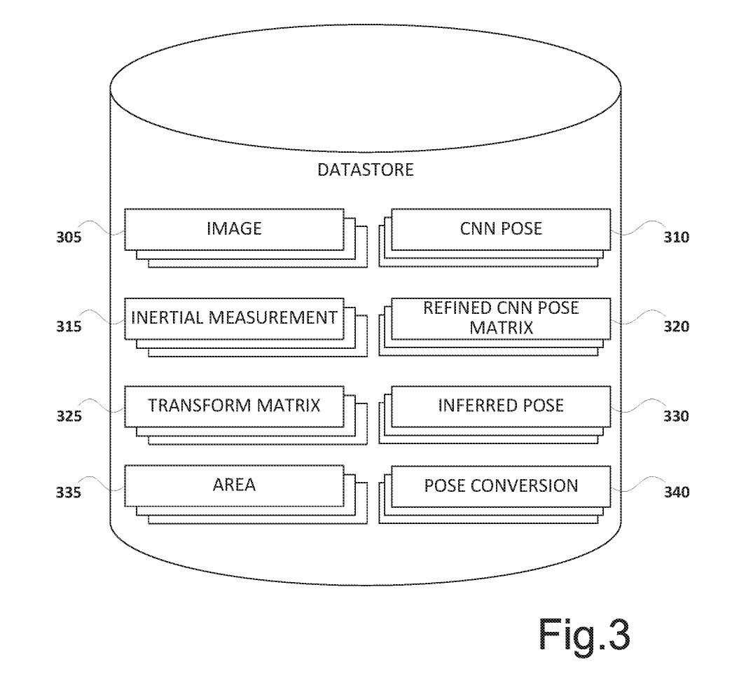

Computer device memory 250 is also illustrated as comprising kernel 285, kernel space 295, user space 290, user protected address space 260, and datastore 300 (illustrated and discussed further in relation to FIG. 3).

Computer device memory 250 may store one or more process 265 (i.e., executing software application(s)). Process 265 may be stored in user space 290. Process 265 and may include one or more other process 265a . . . 265n. One or more process 265 may execute generally in parallel, i.e., as a plurality of processes and/or a plurality of threads.

Computer device memory 250 is further illustrated as storing operating system 280 and/or kernel 285. The operating system 280 and/or kernel 285 may be stored in kernel space 295. In some embodiments, operating system 280 may include kernel 285. One or more process 265 may be unable to directly access kernel space 295. In other words, operating system 280 and/or kernel 285 may attempt to protect kernel space 295 and prevent access by certain processes 265a . . . 265n.

Kernel 285 may be configured to provide an interface between user processes and circuitry associated with mobile computer device 200. In other words, kernel 285 may be configured to manage access to processor 270, chipset 255, I/O ports and peripheral devices by process 265. Kernel 285 may include one or more drivers configured to manage and/or communicate with elements of mobile computer device 200 (i.e., processor 270, chipset 255, I/O ports and peripheral devices).

FIG. 3 is a functional block diagram of the datastore 300 illustrated in mobile computer device 200, according to some embodiments. Datastore 300 may comprise multiple datastores, in and/or remote with respect to mobile computer device 200. Datastore 300 may be distributed. The components of datastore 300 may include data groups used by modules and/or routines, e.g, image 305, CNN pose 310, inertial measurement 315, refined CNN pose matrix 320, transform matrices 325, inferred pose 330, area 335, and pose conversion 340 (to be described more fully below). The data groups used by modules or routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, references to other database entries, joins, conditional logic, tests, and similar.

In overview, image 305 records may comprise images recorded by a digital camera, such as camera 252, including RGB and depth information in relation to pixels. Image 305 records may comprise and/or be associated with time and/or date-time information.

CNN pose 310 records may comprise a pose returned by regression of an image in or relative to a CNN for an area. CNN pose 310 records may encode information such as, for example, location or position (or, equivalently, translation) and rotation angles, such as yaw, pitch, and roll, in a coordinate system, such as, for example, x, y, and z for location, and ry, rp, rr for yaw, pitch, and roll. In addition to using Euler angle forms, other forms of angles may be used, such as weighted quaternion forms, such as a quaternion slerp forms (spherical linear interpolation). CNN pose 310 records may be associated with an image 305 record and/or with a time and/or date-time for when an image was taken, wherein the image was used to generate the CNN pose. CNN pose 310 records may also be referred to herein as, “CNNR(T)”. CNNR(T) may be transformed to a 4×4 pose matrix, M_CNNR(T), in which the left upper 3×3 matrix is related to rotation and the right upper 3×1 matrix is relation to translation. Inertial measurement 315 records may comprise recordings from an inertial measurement unit or units and may record specific force, angular rate, and (optionally) magnetic field. Inertial measurement 315 records may comprise or be associated with time and/or date-time information regarding when the inertial measurements were recorded. Inertial measurement 315 records may also be referred to herein as, “IMU(T)”. IMU(T) may be represented or transformed into a 4×4 matrix M_IMU(T). Inertial measurement 315 records may be obtained at a higher frame rate than images.

Refined CNN pose matrix 320 records may be generated by localization module 400, as discussed further in relation to FIG. 4. In overview, refined CNN pose matrix 320 records encode a refinement to a CNN pose, based on inertial measurements, in a matrix form.

Transform matrices 325 records may be generated by localization module 400, as discussed further in relation to FIG. 4. In overview, transform matrices 325 records may encode a transformation matrix of inertial measurements (M_IMU(T) to a matrix form of a CNN pose (M_CNNR(T)), as M_CNNR(T)*inv(IMU(T)), where M_CNNR(T) is the matrix form of a CNN pose at time T and inv(IMU(T)) is an inverse matrix of inertial measurements at time T.

Inferred pose 330 records may be generated by localization module 400, as discussed further in relation to FIG. 4. In overview, inferred pose 330 records encode a refinement to a CNN pose, based on inertial measurements.

Area 335 records may comprise an identifier of an area, such as area 110. The identifier may be arbitrary and/or may encode a location in a map or coordinate system, such as a latitude and longitude, an address, or the like.

Pose conversion 340 records may be used by, for example, location use module 500 or a similar process to convert an inferred pose 330 into a pose for another device which is connected to the device, camera, or the like which was used to determine the inferred pose 330. For example, if mobile computer device 200 is part of a larger machine, such as an ocean-going tanker, pose conversion 340 records may be used to convert an inferred pose 330 of mobile computer device 200 into a pose of a perimeter of the ocean-going tanker.

FIG. 4 is a flow diagram illustrating an example of a method performed by localization module 400, according to some embodiments. Localization module 400 may be performed by, for example, mobile computer device 200. Localization module 400 may be performed independently or in response to a call by another module or routine, such as in response to a call by location use module 500.

At block 405, localization module 400 may obtain an image. In the example illustrated in FIG. 1, localization module 400 may direct camera 252 to take the image and may store the image as an image 305 record in datastore 300. In other embodiments, localization module 400 may obtain the image from another source, such as from a datastore. As noted, the image may comprise RGB and depth information, as well as a date-time when the image was recorded. An approximate area in which the image was taken may also be recorded and stored in, for example, an area 335 record. Block 405 may be repeated at a rate, though FIG. 4 discusses obtaining one image for the sake of simplicity.

At block 410, localization module 400 may submit the image of block 405 to a CNN for regression analysis. As noted, the CNN may be may be local to the device which obtained the image of block 405 or may be remote, as in a trained CNN for area in CNN server 105, as discussed in relation to FIG. 1. The image may be provided in conjunction with an area identifier, such as an area 335 record, and/or the CNN may be selected to correspond to the area in which the image was taken. The CNN may be trained to perform regression analysis with respect to images taken in the area and to return a pose of the camera (or other device which took the image). At block 410, localization module 400 may also receive from the CNN a CNN pose corresponding to the submitted image. The CNN pose may be stored as, for example, one or more CNN pose 310 records.

At block 415, localization module 400 may obtain inertial measurements from an inertial measurement unit. The inertial measurements may record specific force, angular rate, and (optionally) magnetic field. The measurements may be stored in, for example, one or more inertial measurement 315 records. Inertial measurement 315 records may comprise or be associated with time and/or date-time information regarding when the inertial measurements were recorded. The inertial measurements may also be referred to herein as, “IMU(T)”. IMU(T) may be represented or transformed into a 4×4 matrix M_IMU(T). Inertial measurement 315 records may be obtained at a higher rate than images.

At decision block 420, localization module 400 may determine if a time interval has elapsed since images and inertial measurements began or since the end of the last time interval. The length of the time interval may be selected to balance improvements in accuracy which come with increasing the number of frames, and which thereby tend to increase the time interval, versus factors such as reducing latency in determining inferred position, which may tend to decrease the time interval.

If the time interval has not yet elapsed, localization module 400 may return to block 405 to obtain another image(s) and inertial measurement(s). If the time interval has elapsed, in addition to returning to block 405 (block 405 to 415 may iterate), opening loop block 425 to closing loop block 450 may iterate for a then-current time interval and a set of CNN poses, CNNR(T) to CNNR(T-(N-1)) and inertial measurements, IMU(T) to IMU(T-(N-1)), recorded over the time interval.

At block 430, localization module 400 may weight certain of the CNN poses by weighting factors. For example, an image taken of an object from a large distance may return a less accurate CNN pose than an image of the same object taken from a closer distance. Consequently, a weighting factor which factors in an approximate distance between camera and subject matter (as may be determined from distance information in pixels in image 305 records) or which factors in scale in the image may be used. As another example of a weighting factor, a number of images used to train the CNN may affect the accuracy of CNN poses returned by the CNN. Consequently, the image density used to train the CNN may be a weighting factor.

At block 435, for each measured time in the time interval, localization module 400 may multiply a matrix form of the CNN pose at the time, M_CNNR(T), by an inverse matrix form of an inertial measurement taken at the time, M_IMU(T), to determine a set of transform matrices for the time interval. The determined transform matrices for the time interval may be store as, for example, a set of transform matrix 325 records.

At block 440, localization module 400 may determine a pose corresponding to each transform matrix in the set of transform matrix 325 records of block 435; each such pose may also be referred to herein as a “transform matrix pose”.

At block 445, localization module 400 may determine an average of the transform matrix poses of block 440, for the time interval.

At closing loop block 450, localization module 400 may return to block 425 to iterate over the next time interval and set of CNN poses and inertial measurements over the next time interval, if any.

In addition to returning to block 425, if at all, localization module 400 may proceed to opening loop block 455 to closing loop block 475, to iterate over each time instance in a time interval of blocks 425 to 450.

For each time instance in the then-current time interval, at block 460, localization module 400 may multiply a matrix form of the average transform matrix pose for the time interval (of block 445) by a matrix form of the inertial measurement for the time instance to get a refined CNN pose matrix for the time instance. The refined CNN pose matrix may be stored as, for example, one or more refined CNN pose matrix 320 records.

At block 465, localization module 400 may infer the pose of the camera based on the refined CNN pose matrix of block 460, for example, by converting the refined CNN pose matrix to a coordinate representation. At block 470, refined CNN pose matrix may save the inferred pose as one or more inferred pose 330 records.

At block 475, localization module 400 may return to block 455 to iterate over the next time instance in the then-current time interval, if any.

At block 499, localization module 400 may conclude and/or return to a process which may have spawned or called it.

FIG. 5 is a flow diagram illustrating an example of a method performed by an example of a location use module 500, according to some embodiments. Location use module 500 may process requests for poses, such as an augmented reality display which needs to know its pose in order to overlay images into an appropriate location onto the field of view of the wearer of augmented reality display, or a robot which needs its pose in order to control a robot actuator, such as a wheel, to navigate a building.

At block 505, location use module 500 may receive a call or request for a pose, such as from another module, routine, or process which may need the pose.

At block 400, location use module 500 may call localization module 400 or otherwise obtain an inferred pose for a camera of or associated with localization module 400. For example, the inferred pose may be obtained from a most-recent inferred pose 330 record.

At block 510, location use module 500 may convert the inferred pose 330 record of block 400, which is relative to a camera which took images, to a pose of a device which includes the camera. This conversion may be according to, for example, one or more pose conversion 340 records. The pose conversion 340 records may describe a fixed or variable relationship between the camera which took the images which were submitted to the CNN (and used to determine the refined CNN pose matrix and inferred pose) and a device of which the camera may be a part. For example, if the camera is part of a head of a robot, wherein the head may be mobile relative to the base of the robot, and if the call or request for the pose comes from a process which needs to know the pose of the footprint of the base of the robot, pose conversion 340 records may determine how to transform the pose of the head into a pose of the footprint of the base of the robot.

At block 515, location use module 500 may return the inferred pose and/or the converted inferred pose to the process, routine, or module which requested the pose.

At done block 599, location use module 500 may conclude and/or return to a process which may have called or spawned it.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

As used in any embodiment herein, the term “logic” may refer to the logic of the instructions of an app, software, and/or firmware, and/or the logic embodied into a programmable circuitry by a configuration bit stream, to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as FPGA. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Following are examples:

Example 1. A device for computing, comprising: a computer processor and a memory; and an localization module to infer a pose of the computer device, wherein to infer the pose of the computer device, the localization module is to obtain a convolutional neural network (“CNN”) pose of the computer device at a time and an inertial measurement at the time with respect to the computer device, and adjust the CNN pose based at least in part on the inertial measurement.

Example 2. The device according to Example 1, wherein to adjust the CNN pose based at least in part on the inertial measurement, the localization module is to, with respect to a time interval, for a set of CNN poses and a set of inertial measurements over the time interval, determine a set of transform matrices based on the set of CNN poses and the set of inertial measurements, determine a refined CNN pose matrix based on the set of transform matrices, and infer the pose of the computer device from the refined CNN pose matrix.

Example 3. The device according to Example 2, wherein to determine the refined CNN pose matrix based on the set of transform matrices, the localization module is further to determine a set of transform matrices poses over the time interval based on the set of transform matrices, determine an average transform matrix pose based on the set of transform matrices poses, multiply a matrix form of the average transform matrix pose by a matrix form of the inertial measurement to determine the refined CNN pose matrix, and infer the pose of the computer device from the refined CNN pose matrix.

Example 4. The device according to Example 3, wherein the localization module is further to weigh the CNN pose by a weight factor prior to determine the set of transform matrices based on the set of CNN poses and the set of inertial measurements.

Example 5. The device according to Example 4, wherein the weight factor comprises at least one of a distance between an object in the image and a camera or an image density used to train a CNN, wherein the CNN provided the CNN pose.

Example 6. The device according to Example 2, wherein determine the set of transform matrices based on the CNN poses and the inertial measurements comprises multiply matrices forms of the CNN poses by an inverse matrices forms of the inertial measurements.

Example 7. The device according to any one of Example 1 to Example 6, wherein the computer device is one of a robot, an autonomous or semi-autonomous vehicle, a mobile phone, a laptop computer, a computing tablet, a game console, a set-top box, or a desktop computer.

Example 8. The device according to any one of Example 1 to Example 6, wherein the device further comprises an inertial measurement unit to measure the inertial measurement and wherein the localization module is to obtain the inertial measurement from the inertial measurement unit.

Example 9 The device according to any one of Example 1 to Example 6, wherein the device further comprises a camera to take an image from a perspective of the device, wherein the image is associated with the time, and wherein the localization module is to submit the image to a CNN for regression analysis and is to obtain the CNN pose from the CNN.

Example 10. The device according to any one of Example 1 to Example 6, further comprising a location use module to infer the pose of the computer device according to a relative position of a camera, wherein to infer the pose of the computer device according to the relative position of the camera, for a camera which recorded an image used to obtain the CNN pose, the location use module is to apply a pose conversion factor to a pose obtained in relation to the camera to determine the pose of the computer device.

Example 11. A computer implemented method of inferring a pose of a computer device, comprising:

obtaining, by the computer device, a convolutional neural network (“CNN”) pose of the computer device at a time and an inertial measurement at the time; and

adjusting, by the computer device, the CNN pose based on the inertial measurement to infer the pose of the computer device.

Example 12. The method according to Example 11, wherein adjusting the CNN pose based on the inertial measurement comprises, with respect to a time interval, for a set of CNN poses and a set of inertial measurements over the time interval, determining a set of transform matrices based on the set of CNN poses and the set of inertial measurements, determining a refined CNN pose matrix based on the set of transform matrices, and inferring the pose of the computer device from the refined CNN pose matrix.

Example 13. The method according to Example 12, wherein determining the refined CNN pose matrix based on the set of transform matrices comprises determining a set of transform matrices poses over the time interval based on the set of transform matrices, determining an average transform matrix pose based on the set of transform matrices poses, multiplying a matrix form of the average transform matrix pose by a matrix form of the inertial measurement to determine the refined CNN pose matrix, and inferring the pose of the computer device from the refined CNN pose matrix.

Example 14. The method according to Example 13, further comprising weighing the CNN pose by a weighting factor prior to determining the set of transform matrices based on the set of CNN poses and the set of inertial measurements.

Example 15. The method according to Example 14, wherein the weighing factor comprises a distance between an object in the image and a camera or an image density used to train a CNN, wherein the CNN provided the CNN pose.

Example 16. The method according to Example 12, wherein determining the set of transform matrices based on the CNN poses and the inertial measurements comprises multiplying matrices forms of the CNN poses by an inverse matrices forms of the inertial measurements.

Example 17. The method according to any one of Example 11 to Example 16, further comprising obtaining the inertial measurement at the time from an inertial measurement unit.

Example 18. The method according to any one of Example 11 to Example 16, further comprising obtaining an image associated with the time from a camera, submitting the image to a CNN for regression analysis, and obtaining the CNN pose in response thereto.

Example 19. The method according to any one of Example 11 to Example 16, further comprising inferring the pose of the computer device according to a relative position of a camera which recorded an image used to obtain the CNN pose.

Example 20. An apparatus to infer a pose of a computer device, comprising:

means to obtain a convolutional neural network (“CNN”) pose of the computer device at a time and an inertial measurement at the time with respect to the computer device; and

means to adjust the CNN pose based at least in part on the inertial measurement to infer the pose of the computer device.

Example 21. The apparatus according to Example 20, wherein means to adjust the CNN pose based at least in part on the inertial measurement, comprises, with respect to a time interval, for a set of CNN poses and a set of inertial measurements over the time interval, means to determine a set of transform matrices based on the set of CNN poses and the set of inertial measurements, means to determine a refined CNN pose matrix based on the set of transform matrices, and means to infer the pose of the computer device from the refined CNN pose matrix.

Example 22. The apparatus according to Example 21, wherein means to determine the refined CNN pose matrix based on the set of transform matrices, comprises means to determine a set of transform matrices poses over the time interval based on the set of transform matrices, means to determine an average transform matrix pose based on the set of transform matrices poses, means to multiply a matrix form of the average transform matrix pose by a matrix form of the inertial measurement to determine the refined CNN pose matrix, and means to infer the pose of the computer device from the refined CNN pose matrix.

Example 23. The apparatus according to Example 22, further comprising means to weight the CNN pose by a weighting factor.

Example 24. The apparatus according to Example 23, wherein the weighting factor comprises a distance between an object in the image and a camera or an image density used to train a CNN, wherein the CNN provided the CNN pose.

Example 25. The apparatus according to Example 21, wherein means to determine the set of transform matrices based on the CNN poses and the inertial measurements comprises means to multiply matrices forms of the CNN poses by an inverse matrices forms of the inertial measurements.

Example 26. The apparatus according to any one of Example 20 to Example 25, wherein the computer device is one of a robot, a camera, and a mobile phone, and a laptop computer.

Example 27. The apparatus according to any one of Example 20 to Example 25, wherein the apparatus comprises an inertial measurement unit to measure the inertial measurement and wherein the apparatus further comprises means to obtain the inertial measurement from the inertial measurement unit.

Example 28. The apparatus according to any one of Example 20 to Example 25, wherein the apparatus comprises a camera to take an image from a perspective of the apparatus, wherein the apparatus further comprises means to submit the image to a CNN for regression analysis and means to obtain the CNN pose from the CNN, wherein the image is associated with the time.

Example 29. The apparatus according to any one of Example 20 to Example 25, further comprising means to infer the pose of the computer device according to a relative position of a camera which recorded an image used to obtain the CNN pose.

Example 30. One or more computer-readable media comprising instructions that cause a computer device, in response to execution of the instructions by a processor of the computer device, to:

obtain a convolutional neural network (“CNN”) pose of the computer device at a time and an inertial measurement at the time, and adjust the CNN pose based at least in part on the inertial measurement to infer a pose of the computer device.

Example 31. The computer-readable media according to Example 30, wherein adjust the CNN pose based at least in part on the inertial measurement comprises, with respect to a time interval, for a set of CNN poses and a set of inertial measurements over the time interval, determine a set of transform matrices based on the set of CNN poses and the set of inertial measurements, determine a refined CNN pose matrix based on the set of transform matrices, and infer the pose of the computer device from the refined CNN pose matrix.

Example 32. The computer-readable media according to Example 31, wherein determine the refined CNN pose matrix based on the set of transform matrices comprises determine a set of transform matrices poses over the time interval based on the set of transform matrices, determine an average transform matrix pose based on the set of transform matrices poses, multiply a matrix form of the average transform matrix pose by a matrix form of the inertial measurement to determine the refined CNN pose matrix, and infer the pose of the computer device from the refined CNN pose matrix.

Example 33. The computer-readable media according to Example 32, further comprising weight the CNN pose by a weighting factor prior to determine the set of transform matrices based on the set of CNN poses and the set of inertial measurements.

Example 34. The computer-readable media according to Example 33, wherein the weighting factor comprises a distance between an object in the image and a camera and an image density used to train a CNN, wherein the CNN provided the CNN pose.

Example 35. The computer-readable media according to Example 31, wherein determine the set of transform matrices based on the CNN poses and the inertial measurements comprises multiply matrices forms of the CNN poses by an inverse matrices forms of the inertial measurements.

Example 36. The computer-readable media according to any one of Example 11 to Example 16, wherein the computer device is one of a robot, a camera, and a mobile phone, and a laptop computer.

Example 37. The computer-readable media according to any one of Example 30 to Example 36, wherein the instructions are further to cause the computer device to obtain the inertial measurement at the time from an inertial measurement unit coupled to a camera.

Example 38. The computer-readable media according to any one of Example 30 to Example 36, wherein the instructions are further to cause the computer device to obtain an image associated with the time from a camera, submit the image to a CNN for regression analysis, and obtaining the CNN pose in response thereto.

Example 39. The computer-readable media according to any one of Example 30 to Example 36, wherein the instructions are further to cause the computer device to infer the pose of the computer device according to a relative position of a camera which recorded an image used to obtain the CNN pose.

Example 40. A system to infer a pose of a computer device comprising a computer processor, a memory, and a robot actuator, wherein to infer the pose of the computer device, the processor is to obtain a convolutional neural network (“CNN”) pose of the computer device at a time and an inertial measurement at the time with respect to the computer device and is to adjust the CNN pose based at least in part on the inertial measurement.

Example 41. The system according to Example 40, wherein to adjust the CNN pose based at least in part on the inertial measurement, the processor is to, with respect to a time interval, for a set of CNN poses and a set of inertial measurements over the time interval, determine a set of transform matrices based on the set of CNN poses and the set of inertial measurements, determine a refined CNN pose matrix based on the set of transform matrices, and infer the pose of the computer device from the refined CNN pose matrix.

Example 42. The system according to Example 41, wherein to determine the refined CNN pose matrix based on the set of transform matrices, the processor is further to determine a set of transform matrices poses over the time interval based on the set of transform matrices, determine an average transform matrix pose based on the set of transform matrices poses, multiply a matrix form of the average transform matrix pose by a matrix form of the inertial measurement to determine the refined CNN pose matrix, and infer the pose of the computer device from the refined CNN pose matrix.

Example 43. The system according to Example 42, wherein the processor is further to weight the CNN pose by a weighting factor prior to determine the set of transform matrices based on the set of CNN poses and the set of inertial measurements.

Example 44. The system according to Example 43, wherein the weighting factor comprises at least one of a distance between an object in the image and a camera or an image density used to train a CNN, wherein the CNN provided the CNN pose.

Example 45. The system according to Example 41, wherein determine the set of transform matrices based on the CNN poses and the inertial measurements comprises multiply matrices forms of the CNN poses by an inverse matrices forms of the inertial measurements.

Example 46. The system according to any one of Example 40 to Example 45, wherein the system comprises an inertial measurement unit to measure the inertial measurement and wherein the processor is to obtain the inertial measurement from the inertial measurement unit.

Example 47. The system according to any one of Example 40 to Example 45, wherein the system comprises a camera to take an image from a perspective of the system, wherein the processor is to submit the image to a CNN for regression analysis and is to obtain the CNN pose from the CNN, wherein the image is associated with the time.

Example 48. The system according to any one of Example 40 to Example 45, wherein the processor is further to infer the pose of the computer device according to a relative position of a camera, wherein to infer the pose of the computer device according to the relative position of the camera, for a camera which recorded an image used to obtain the CNN pose, the processor is to apply a pose conversion factor to a pose obtained in relation to the camera to determine the pose of the computer device.

Example 49. The system according to any one of Example 40 to Example 45, wherein the processor is further to control the robot actuator according to the pose of the computer device to navigate the computer device through an area.

1. A device for computing, comprising: a computer processor and a memory; and an localization module to infer a pose of the computer device, wherein to infer the pose of the computer device, the localization module is to obtain a convolutional neural network (“CNN”) pose of the computer device at a time and an inertial measurement at the time with respect to the computer device, and adjust the CNN pose based at least in part on the inertial measurement.

2. The device according to claim 1, wherein to adjust the CNN pose based at least in part on the inertial measurement, the localization module is to, with respect to a time interval, for a set of CNN poses and a set of inertial measurements over the time interval, determine a set of transform matrices based on the set of CNN poses and the set of inertial measurements, determine a refined CNN pose matrix based on the set of transform matrices, and infer the pose of the computer device from the refined CNN pose matrix, wherein determine the set of transform matrices based on the CNN poses and the inertial measurements comprises multiply matrices forms of the CNN poses by an inverse matrices forms of the inertial measurements.

3. The device according to claim 2 wherein to determine the refined CNN pose matrix based on the set of transform matrices, the localization module is further to determine a set of transform matrices poses over the time interval based on the set of transform matrices, determine an average transform matrix pose based on the set of transform matrices poses, multiply a matrix form of the average transform matrix pose by a matrix form of the inertial measurement to determine the refined CNN pose matrix, and infer the pose of the computer device from the refined CNN pose matrix.

4. The device according to claim 3, wherein the localization module is further to weigh the CNN pose by a weight factor prior to determine the set of transform matrices based on the set of CNN poses and the set of inertial measurements, wherein the weight factor comprises at least one of a distance between an object in the image and a camera or an image density used to train a CNN, wherein the CNN provided the CNN pose.

5. The device according to claim 1, wherein the computer device is one of a robot, an autonomous or semi-autonomous vehicle, a mobile phone, a laptop computer, a computing tablet, a game console, a set-top box, or a desktop computer, wherein the device further comprises an inertial measurement unit to measure the inertial measurement and wherein the localization module is to obtain the inertial measurement from the inertial measurement unit, and wherein the device further comprises a camera to take an image from a perspective of the device, wherein the image is associated with the time, and wherein the localization module is to submit the image to a CNN for regression analysis and is to obtain the CNN pose from the CNN.

6. The device according to claim 1, further comprising a location use module to infer the pose of the computer device according to a relative position of a camera, wherein to infer the pose of the computer device according to the relative position of the camera, for a camera which recorded an image used to obtain the CNN pose, the location use module is to apply a pose conversion factor to a pose obtained in relation to the camera to determine the pose of the computer device.

7. A computer implemented method of inferring a pose of a computer device, comprising:
obtaining, by the computer device, a convolutional neural network (“CNN”) pose of the computer device at a time and an inertial measurement at the time; and adjusting, by the computer device, the CNN pose based on the inertial measurement to infer the pose of the computer device.

8. The method according to claim 7, wherein adjusting the CNN pose based on the inertial measurement comprises, with respect to a time interval, for a set of CNN poses and a set of inertial measurements over the time interval, determining a set of transform matrices based on the set of CNN poses and the set of inertial measurements, determining a refined CNN pose matrix based on the set of transform matrices, and inferring the pose of the computer device from the refined CNN pose matrix, wherein determining the set of transform matrices based on the CNN poses and the inertial measurements comprises multiplying matrices forms of the CNN poses by an inverse matrices forms of the inertial measurements.

9. The method according to claim 8, wherein determining the refined CNN pose matrix based on the set of transform matrices comprises determining a set of transform matrices poses over the time interval based on the set of transform matrices, determining an average transform matrix pose based on the set of transform matrices poses, multiplying a matrix form of the average transform matrix pose by a matrix form of the inertial measurement to determine the refined CNN pose matrix, and inferring the pose of the computer device from the refined CNN pose matrix.

10. The method according to claim 9, further comprising weighing the CNN pose by a weighting factor prior to determining the set of transform matrices based on the set of CNN poses and the set of inertial measurements, wherein the weighing factor comprises at least one of a distance between an object in the image and a camera or an image density used to train a CNN, wherein the CNN provided the CNN pose.

11. The method according to claim 7, further comprising obtaining the inertial measurement at the time from an inertial measurement unit, obtaining an image associated with the time from a camera, submitting the image to a CNN for regression analysis, and obtaining the CNN pose in response thereto.

12. The method according to claim 7, further comprising inferring the pose of the computer device according to a relative position of a camera which recorded an image used to obtain the CNN pose.

13. An apparatus to infer a pose of a computer device, comprising:
means to obtain a convolutional neural network (“CNN”) pose of the computer device at a time and an inertial measurement at the time with respect to the computer device; and
means to adjust the CNN pose based at least in part on the inertial measurement to infer the pose of the computer device.

14. The apparatus according to claim 13, wherein means to adjust the CNN pose based at least in part on the inertial measurement, comprises, with respect to a time interval, for a set of CNN poses and a set of inertial measurements over the time interval, means to determine a set of transform matrices based on the set of CNN poses and the set of inertial measurements, means to determine a refined CNN pose matrix based on the set of transform matrices, and means to infer the pose of the computer device from the refined CNN pose matrix, wherein means to determine the set of transform matrices based on the CNN poses and the inertial measurements comprises means to multiply matrices forms of the CNN poses by an inverse matrices forms of the inertial measurements.

15. The apparatus according to claim 14, wherein means to determine the refined CNN pose matrix based on the set of transform matrices, comprises means to determine a set of transform matrices poses over the time interval based on the set of transform matrices, means to determine an average transform matrix pose based on the set of transform matrices poses, means to multiply a matrix form of the average transform matrix pose by a matrix form of the inertial measurement to determine the refined CNN pose matrix, and means to infer the pose of the computer device from the refined CNN pose matrix.

16. The apparatus according to claim 15, further comprising means to weight the CNN pose by a weighting factor, wherein the weighting factor comprises at least one of a distance between an object in the image and a camera or an image density used to train a CNN, wherein the CNN provided the CNN pose.

17. The apparatus according to claim 13, wherein the computer device is one of a robot, an autonomous or semi-autonomous vehicle, a mobile phone, a laptop computer, a computing tablet, a game console, a set-top box, or a desktop computer, wherein the apparatus comprises an inertial measurement unit to measure the inertial measurement and wherein the apparatus further comprises means to obtain the inertial measurement from the inertial measurement unit, wherein the apparatus comprises a camera to take an image from a perspective of the apparatus, wherein the apparatus further comprises means to submit the image to a CNN for regression analysis and means to obtain the CNN pose from the CNN, wherein the image is associated with the time.

18. The apparatus according to claim 13, further comprising means to infer the pose of the computer device according to a relative position of a camera which recorded an image used to obtain the CNN pose.

19. One or more computer-readable media comprising instructions that cause a computer device, in response to execution of the instructions by a processor of the computer device, to:
obtain a convolutional neural network (“CNN”) pose of the computer device at a time and an inertial measurement at the time, and adjust the CNN pose based at least in part on the inertial measurement to infer a pose of the computer device.

20. The computer-readable media according to claim 19, wherein adjust the CNN pose based at least in part on the inertial measurement comprises, with respect to a time interval, for a set of CNN poses and a set of inertial measurements over the time interval, determine a set of transform matrices based on the set of CNN poses and the set of inertial measurements, determine a refined CNN pose matrix based on the set of transform matrices, and infer the pose of the computer device from the refined CNN pose matrix, wherein determine the set of transform matrices based on the CNN poses and the inertial measurements comprises multiply matrices forms of the CNN poses by an inverse matrices forms of the inertial measurements.

21. The computer-readable media according to claim 20, wherein determine the refined CNN pose matrix based on the set of transform matrices comprises determine a set of transform matrices poses over the time interval based on the set of transform matrices, determine an average transform matrix pose based on the set of transform matrices poses, multiply a matrix form of the average transform matrix pose by a matrix form of the inertial measurement to determine the refined CNN pose matrix, and infer the pose of the computer device from the refined CNN pose matrix.

22. The computer-readable media according to claim 21, further comprising weight the CNN pose by a weighting factor prior to determine the set of transform matrices based on the set of CNN poses and the set of inertial measurements, wherein the weighting factor comprises at least one of a distance between an object in the image and a camera or an image density used to train a CNN, wherein the CNN provided the CNN pose.

23. The computer-readable media according to claim 19, wherein the computer device is one of a robot, an autonomous or semi-autonomous vehicle, a mobile phone, a laptop computer, a computing tablet, a game console, a set-top box, or a desktop computer, wherein the instructions are further to cause the computer device to obtain the inertial measurement at the time from an inertial measurement unit coupled to a camera, wherein the instructions are further to cause the computer device to obtain an image associated with the time from a camera, submit the image to a CNN for regression analysis, and obtaining the CNN pose in response thereto.

24. The computer-readable media according to claim 19, wherein the instructions are further to cause the computer device to infer the pose of the computer device according to a relative position of a camera which recorded an image used to obtain the CNN pose.

25. (canceled)
